(19) United States
(12) Patent Application Publication
(10) Pub. No.: US 2024/0139893 A1
(43) Pub. Date: May 2, 2024

(54) AUTO FEED FASTENER TOOL

(71) Applicant: House of Design LLC, Nampa, ID (US)

(72) Inventors: Anthony Wayne Foster, Middleton, ID (US); Chris Brown, Nampa, ID (US)

(21) Appl. No.: 18/494,616

(22) Filed: Oct. 25, 2023

Related U.S. Application Data
(60) Provisional application No. 63/381,537, filed on Oct. 28, 2022.

(51) Int. Cl. B23P 19/00; B23P 19/06

(52) U.S. Cl. CPC B23P 19/001; B23P 19/06

(57) ABSTRACT

A fastener gun may include a driver configured to drive a fastener of a fastener strip a plate coupled to the driver, wherein the plate is configured to receive the fastener strip a nose piece coupled to the plate, wherein the nose piece is configured to hold the fastener strip adjacent the plate, and a feeder mechanism coupled to the plate and configured to advance the fastener strip towards the driver.

### CROSS-REFERENCE TO RELATED APPLICATIONS

This application is a continuation of U.S. Provisional Application No. 63/381,537 filed Oct. 28, 2022, which application is herein incorporated by reference in its entirety.

### TECHNICAL FIELD

The present disclosure relates generally to the field of fastener systems. More particularly, the disclosure is directed to fastener guns of automated fastener systems.

### BRIEF DESCRIPTION OF THE DRAWINGS

The written disclosure herein describes illustrative embodiments that are non-limiting and non-exhaustive. Reference is made to certain of such illustrative embodiments that are depicted in the figures, in which:

FIG. 1A is a side view of a fastener system, according to one embodiment of the present disclosure.

FIG. 1B is a side view of the fastener system of FIG. 1A driving a fastener, according to one embodiment of the present disclosure.

FIG. 2 is a perspective view of a fastener system, according to one embodiment of the present disclosure.

FIG. 3 is a perspective view of a fastener tool, according to one embodiment of the present disclosure.

FIG. 4 is a back perspective view of the fastener tool of FIG. 3.

FIG. 5 is a back view of the fastener tool of FIG. 3.

FIG. 6A is a perspective view of a fastener tool, according to one embodiment of the present disclosure.

FIG. 6B is a close-up of a portion of the fastener tool of FIG. 6A.

FIG. 7 is a lower perspective view of the fastener tool of FIG. 6A.

FIG. 8 is a back perspective view of the fastener tool of FIG. 6A.

FIG. 9 is a right side view of the fastener tool of FIG. 6A.

FIG. 10 is a lower perspective view of a fastener tool before a feeder mechanism is engaged, according to one embodiment of the present disclosure.

FIG. 11 is a lower perspective view of the fastener tool of FIG. 10 as the feeder mechanism is being engaged, according to one embodiment of the present disclosure.

FIG. 12 is a lower perspective view of the fastener tool of FIG. 10 after the feeder mechanism is engaged, according to one embodiment of the present disclosure.

FIG. 13 is a lower perspective view of the fastener tool of FIG. 10 driving a fastener, according to one embodiment of the present disclosure.

FIG. 14 is a flow chart illustrating a process for driving a fastener using a fastener tool, according to one embodiment of the present disclosure.

### DETAILED DESCRIPTION

A fastener system as described herein may be a fastener system for inserting fasteners to attach or fasten materials together or otherwise secure one object to another object. The fastener system may be a robot fastener system or an automated fastener system. For example, the fastener system may include several screw guns that automatically insert screws to bind materials together. Each screw gun may be fed by a magazine which feeds a strip of screws to the screw gun.

The components of the embodiments as generally described and illustrated in the figures herein can be arranged and designed in a wide variety of different configurations. Thus, the following more detailed description of various embodiments, as represented in the figures, is not intended to limit the scope of the present disclosure, but is merely representative of various embodiments. While various aspects of the embodiments are presented in drawings, the drawings are not necessarily drawn to scale unless specifically indicated.

References to approximations are made throughout this specification, such as by use of the term “substantially.” For each such reference, it is to be understood that, in some embodiments, the value, feature, or characteristic may exist without approximation. For example, where qualifiers such as “about” and “substantially” are used, these terms include within their scope the qualified words in the absence of their qualifiers. For example, where the term “substantially perpendicular” is recited with respect to a feature, it is understood that in some embodiments the feature may have a precisely perpendicular configuration.

The phrase “coupled to” is broad enough to refer to any suitable coupling or other form of interaction between two or more entities, including mechanical interaction. Thus, two components may be coupled to each other even though they are not in direct contact with each other.

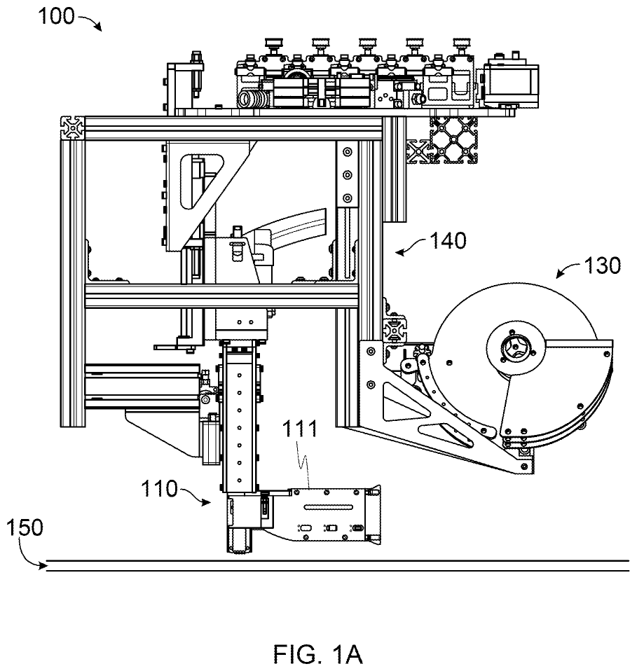

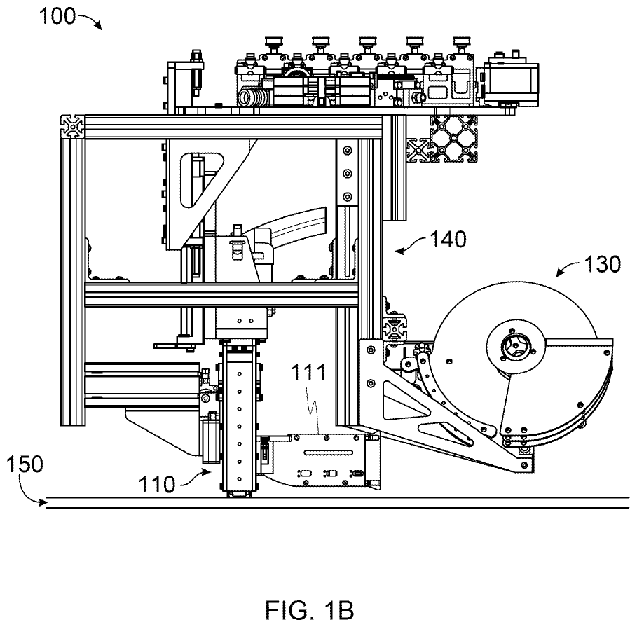

FIG. 1A is a side view of a fastener system 100, according to one embodiment of the present disclosure. The fastener system 100 may include a fastener tool 110, a magazine 130, and a frame 140. The fastener tool 110 may be attached to the frame 140. The fastener tool 110 may be configured to drive a fastener into a surface 150 of a material (e.g., plywood, lumber, wallboard). The fastener tool 110 may be configured to receive a fastener strip from the magazine 130. In some embodiments, the fastener tool 110 may be a screw gun configured to drive screws into the surface 150. The fastener tool 110 may include a feeder 111. The feeder 111 may be movable relative to the frame 140. The feeder 111 may move relative to the frame 140 as the fastener tool 110 drives a fastener into the surface 150, as shown in FIG. 1B. The magazine 130 may be configured to receive a fastener strip (not shown). In some embodiments, the magazine 130 may be configured to support a coiled fastener strip. The coiled fastener strip may uncoil as the fastener strip is fed to the fastener tool 110. The magazine 130 may be removably mounted on the frame 140.

In some embodiments, the fastener system 100 may include a plurality of fastener tools and a plurality of magazines attached to the frame 140. Each of the plurality of fastener tools may be associated with and be fed a fastener strip from a magazine of the plurality of magazines. Each of the plurality of fastener tools may be movable or movably attached to the frame 140. In some embodiments, a first fastener tool of the plurality of fastener tools drives a first type of fastener into the surface and a second fastener tool of the plurality of fastener tools drives a second type of fastener into the surface.

FIG. 1B is a side view of the fastener system of FIG. 1A driving a fastener, according to one embodiment of the present disclosure. The feeder 111 may be movable relative to the frame 140. The feeder 111 may be slidably mounted to or within the fastener tool 110 such that the feeder 111 may move relative to the frame as the fastener tool 110 drives a fastener into the surface 150. In some embodiments, the frame 140 moves towards the surface 150 as the fastener tool 110 drives the fastener into the surface 150. In some embodiments, the movement of the frame 140 towards the surface 150 provides a force for driving the fastener into surface 150.

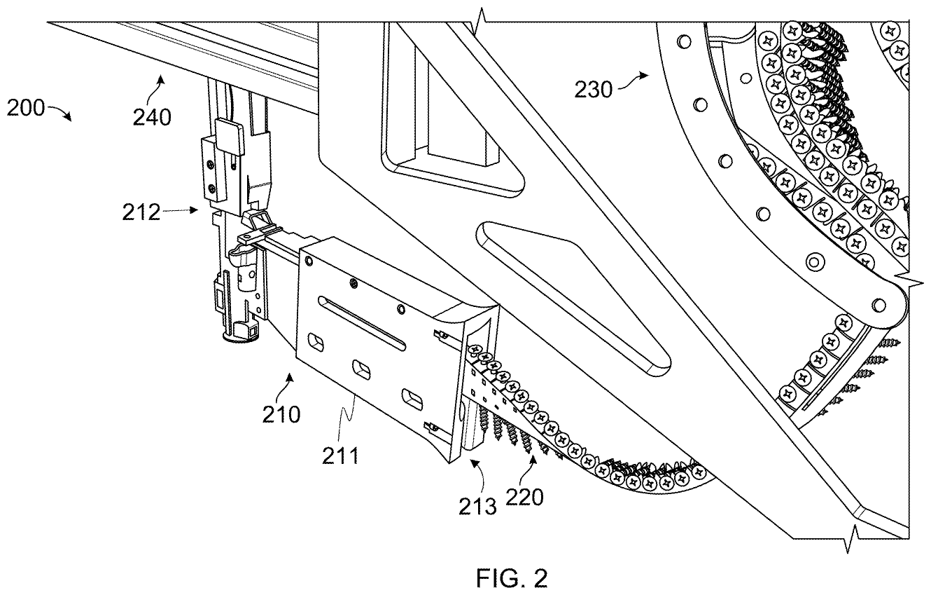

FIG. 2 is a perspective view of a fastener system 200, according to one embodiment of the present disclosure. The fastener system 200 may include a fastener tool 210, a fastener strip 220, a magazine 230, and a frame 240. The fastener system 200 may be similar to the fastener system 100 of FIG. 1. The fastener tool 210 may be movably mounted on the frame 240. The magazine 230 may be removably mounted on the frame 240. The magazine 230 may be configured to receive and support the fastener strip 220. The fastener strip 220 may be supported in the magazine 230 in a coiled configuration. The fastener strip 220 may uncoil as it is fed from the magazine 230 to the fastener tool 210. The fastener strip 220 may be fed to a feeder end 213 of a feeder 211 of the fastener tool 210. The fastener strip 220 may pass through the feeder 211 of the fastener tool 210 towards a driver 212 of the fastener tool. The driver 212 may be configured to drive fasteners of the fastener strip 220 into a surface.

The fastener strip 220 may include a plurality of fasteners. In some embodiments, the fastener strip 220 includes a backing to which the plurality of fasteners are attached. In some embodiments, the backing is plastic. In some embodiments, the plurality of fasteners are screws. In some embodiments, the plurality of fasteners are nails. In some embodiments, the plurality of fasteners are staples.

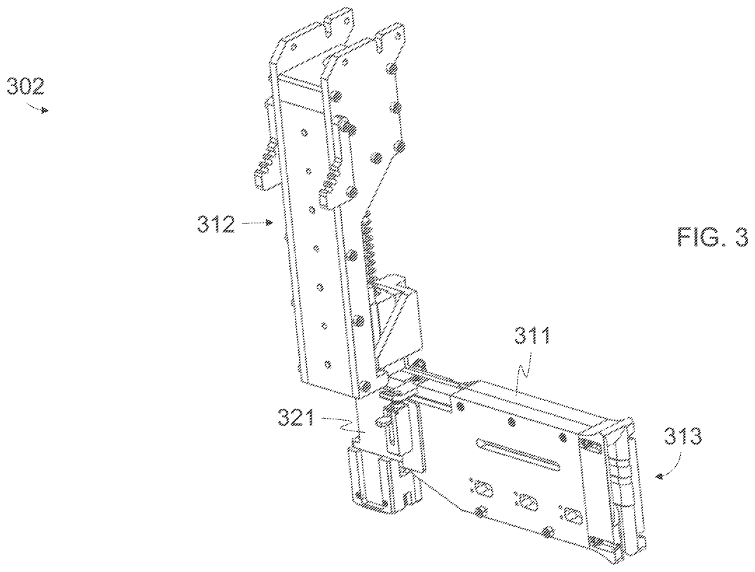

FIG. 3 is a perspective view of a fastener tool 310, according to one embodiment of the present disclosure. The fastener tool 310 may be part of a fastener system, such as the fastener system 100 of FIG. 1. The fastener tool 310 may include a driver 312 and a feeder 311. The feeder 311 may include a feeder end 313 through which a fastener strip may pass to reach the driver 312. The driver 312 may be configured to drive fasteners of the fastener strip into a surface. The fastener tool 310 may include a fastener chamber 321 in which a fastener of the fastener strip may be held as the driver 312 drives the fastener into the surface. As the driver 312 drives the fastener into the surface, the driver 312 may move relative to the feeder 311, or the feeder 311 may move relative to the driver 312. For example, the fastener tool 310 may descend towards the surface until the fastener tool 310 contacts the surface, at which point the feeder 311 and fastener chamber 321 are static relative to the surface. The driver 312 slides downwards relative to the feeder 311 as the driver 312 drives the fastener through the fastener chamber 321 into the surface. In some embodiments, the driver 312 may be fixed relative to a frame (not shown). The frame may move relative to the feeder 311 when the feeder 311 is in contact with the surface. The feeder 311 may move with the frame when the feeder 311 is not in contact with the surface.

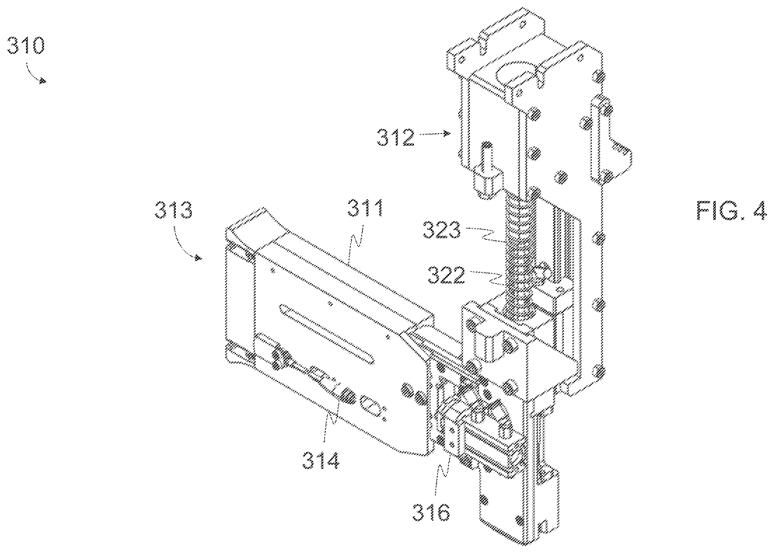

FIG. 4 is a back perspective view of the fastener tool 310 of FIG. 3. The fastener tool 310 may include an actuator 316. The actuator 316 may be configured to advance the fastener strip toward the driver 312. The actuator 316 may be configured to advance the fastener strip toward the driver the distance corresponding to a single fastener being fed into the driver 312. The actuator 316 may be configured to advance the fastener strip each time the fastener tool 310 drives a fastener into the surface. In some embodiments, the actuator 316 may be a pneumatic actuator. In other embodiments, the actuator 316 may be an electromagnetic actuator.

The fastener tool 310 may include a sensor 314. The sensor 314 may sense a position of the fastener strip. The sensor 314 may sense movement of the fastener strip as the fastener strip passes through the feeder 311. In some embodiments, the sensor 314 is attached to an outside of the feeder 311. In other embodiments, the sensor 314 is inside the feeder 311. In yet other embodiments, the sensor 314 is attached to the driver 312. In some embodiments, the sensor 314 is an optical sensor. In some embodiments, the sensor 314 is a laser sensor. In some embodiments, the sensor 314 is a magnetic sensor. In some embodiments, the sensor 314 is a proximity sensor.

In some embodiments, the sensor 314 is configured to detect a distance traveled by the fastener strip within the feeder. The sensor 314 may detect whether the fastener strip travels a distance corresponding to a single fastener being fed into the driver 312. The distance may correspond to a distance between fasteners in the fastener strip. The sensor 314 may send a signal to the driver 312 or a controller of the fastener system of the distance traveled by the fastener strip. The sensor 314 may send a signal to the driver 312 or the controller indicating whether the fastener strip traveled the distance corresponding to a single fastener being fed into the driver 312. In some embodiments, in response to detecting that the fastener strip traveled the distance corresponding to a single fastener being fed into the driver 312, the sensor 314 may send a signal to the driver 312 to drive a fastener into the surface. In some embodiments, in response to detecting that the fastener strip did not travel the distance corresponding to a single fastener being fed into the driver 312, the sensor 314 may send a signal to the actuator 316 to advance the fastener strip toward the driver 312. The sensor 314 may track a number of times the actuator 316 attempts to advance the fastener strip without advancing the fastener strip the distance corresponding to a single fastener being fed into the driver 312. The sensor 314 may send an alert to an operator of the fastener tool 310 after a predetermined number of attempts, or a predetermined number of times that the faster strip did not advance toward the driver such that one fastener entered the driver.

The fastener tool 310 may include a driver shaft 322 and a driver spring 323. The driver shaft may include a driver head (not shown) which engages the fastener to drive the fastener into the surface. The driver shaft may be fixed relative to the driver 312 and move relative to the feeder 311 as the driver 312 drives the fastener into the surface. The driver spring 323 may bias the driver 312 upwards relative to the feeder 311 and may return the driver to the configuration shown in FIG. 4 after the driver 312 has moved downwards relative to the feeder 311 to drive the fastener into the surface.

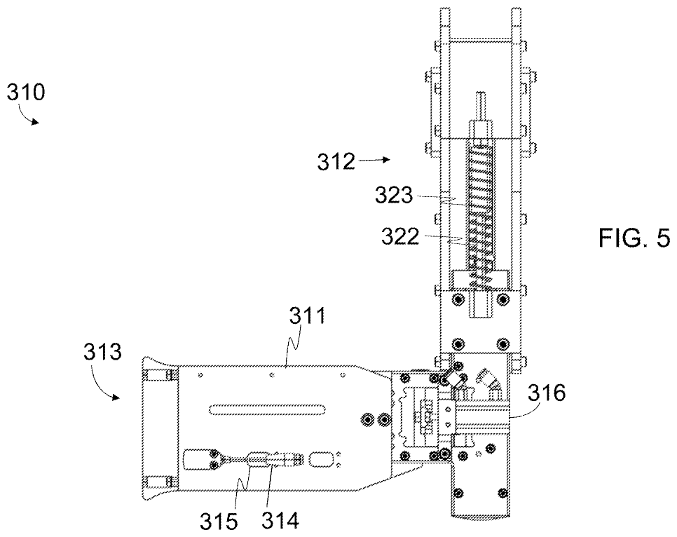

FIG. 5 is a back view of the fastener tool 310 of FIG. 3. In some embodiments, the actuator 316 may extend into the feeder 311 to advance the fastener strip toward the driver 312. In some embodiments, the actuator 316 may be configured to move the fastener strip either toward or away from the driver 312. For example, the actuator 316 may advance the fastener strip toward the driver 312 and, in response to the sensor 314 detecting that the fastener strip advanced too far, the actuator 316 may move the fastener strip away from the driver 312. In another example, the actuator 316 may move the fastener strip away from the driver 312 in response to a jam in the driver 312.

In some embodiments, the feeder 311 may include an opening 315 through which the sensor 314 detects the movement of the fastener strip.

The fastener tool 310 may include a driver shaft 322 and a driver spring 323. The driver shaft may include a driver head (not shown) which engages the fastener to drive the fastener into the surface. The driver shaft may be fixed relative to the driver 312 and move relative to the feeder 311 as the driver 312 drives the fastener into the surface. The driver spring 323 may bias the driver 312 upwards relative to the feeder 311 and may return the driver to the configuration shown in FIG. 5 after the driver 312 has moved downwards relative to the feeder 311 to drive the fastener into the surface.

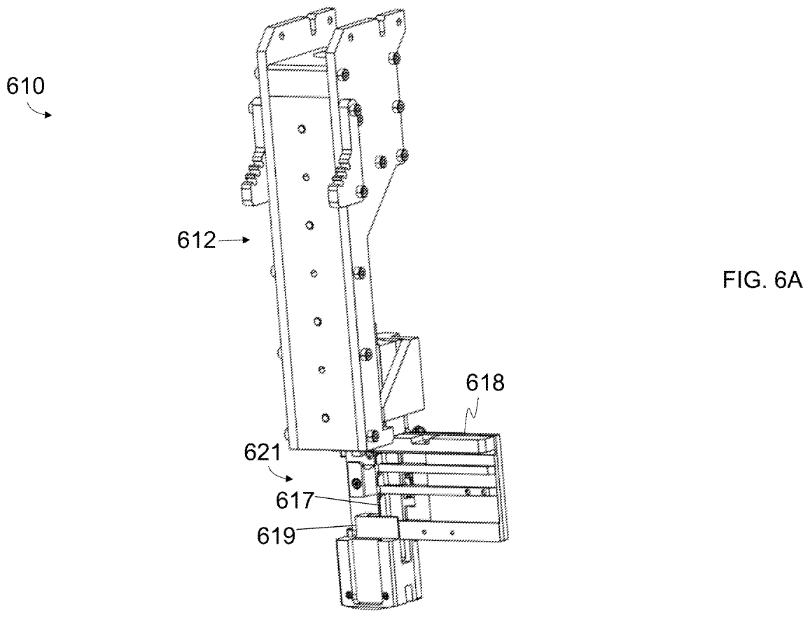

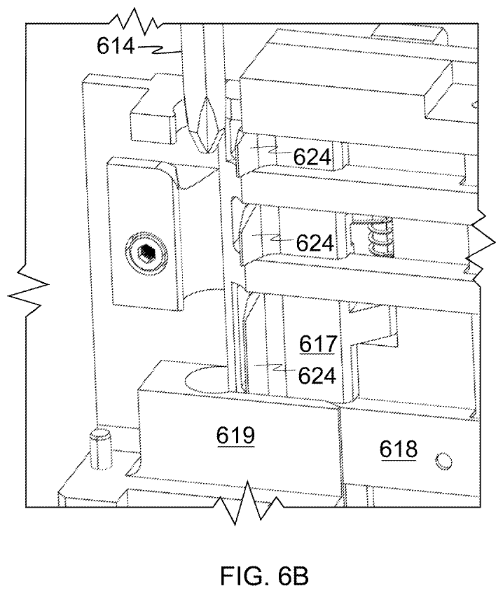

FIG. 6A is a front perspective view of a fastener tool 610, according to one embodiment of the present disclosure. The fastener tool 610 may be similar to the fastener tool 310 of FIG. 3, with the feeder 311 removed. The fastener tool 610 may include a driver 612, a feeder mechanism 617, a plate 618, and a nose piece 619. The driver 612 may be configured to drive a fastener of a fastener strip into a surface. For example, the driver 612 may be configured to drive screws from a strip of screws into a surface, where the strip of screws includes a plastic backing configured to hold the screws evenly spaced apart.

The plate 618 may be configured to receive the fastener strip. The plate 618 may be configured to receive the fastener strip on a first side of the plate 618. The plate 618 may be sized based on a size of the fastener strip. A height of the plate 618 may be greater than or equal to a height of the fastener strip. In some embodiments, the height of the plate 618 may be substantially equal to the height of the fastener strip. The plate 618 may be removably coupled to the driver 612. In some embodiments, the plate 618 may be optimally sized for a particular type of fastener strip. The plate 618 may be removed from the driver 612 and replaced with a second plate based on a type of fastener strip used. For example, the plate 618 may be sized to receive 2-inch screws. If 3-inch screws are to be used, the plate 618 may be removed from the driver 612 and a second plate for use with 3-inch screws may be attached to the driver 612. In some embodiments, a sensor similar to the sensor 314 of FIG. 4 may be coupled to a second side of the plate 618 opposite the first side. The plate 618 may include an opening through which the sensor detects movement of the fastener strip.

The feeder mechanism 617 may be coupled to the plate 618. The feeder mechanism 617 may be configured to advance the fastener strip towards the driver 612. In some embodiments, the feeder mechanism 617 is coupled to the second side of the plate 618 opposite the first side. The feeder mechanism 617 may pass through the plate 618 to advance the fastener strip. The movement of the feeder mechanism is described in greater detail below.

The nose piece 619 may be removably coupled to the plate 618. The nose piece 619 may be configured to prevent the fastener strip from moving away from the first side of the plate 618. The nose piece 619 may be configured to hold a portion of the fastener strip against the plate 618. In some embodiments, the nose piece 619 may be optimally sized for a particular type of fastener strip. The nose piece 619 may be removed from the plate 618 and replaced with a second nose piece based on a type of fastener strip used. For example, the nose piece 619 may be sized to receive 2-inch screws. If 3-inch screws are to be used, the nose piece 619 may be removed from the plate 618 and a second plate for use with 3-inch screws may be attached to the plate 618. In some embodiments, the plate 318 and the attached nose piece 319 may be removed together and replaced with the second plate and second nose piece based on the type of fastener strip used.

The nose piece 619 and the plate 618 may form or define a fastener chamber 621 in which the fastener is held as the driver 612 drives the fastener into the surface. In some embodiments, the feeder mechanism 617 may form or define the fastener chamber 621 with the nose piece 619 and the plate 618 when the feeder mechanism 617 is actuated to advance the fastener into the fastener chamber 621. In some embodiments, a feeder (not shown) may form the fastener chamber 621 with the nose piece 619, the plate 618, and the feeder mechanism 617.

FIG. 6B is a close-up of the fastener chamber 621 of the fastener tool 610 of FIG. 6A. A driver head 614 may be a portion of the driver which engages the fastener as the driver drives the fastener into the surface. For example, the driver head may be configured to engage, as shown, a head of a Philips-head screw to turn the screw as the driver drives the screw into the surface. The driver head 614 may be configured to engage a flathead screw, a nail, a staple, or any kind of fastener. The nose piece 319 may be configured to receive the fastener for the driver head 614 to engage the fastener. The feeder mechanism 617 may be configured to advance the fastener into position in the fastener chamber 621 for the driver head 614 to engage the fastener and secure the fastener in position as the driver drives the fastener into the surface. The feeder mechanism 617 may include one or more rigid members 624. The one or more rigid members 624 may be configured to engage the fastener strip as the feeder mechanism 617 is actuated to advance the fastener strip into the fastener chamber 621 so the driver head 614 can engage the fastener.

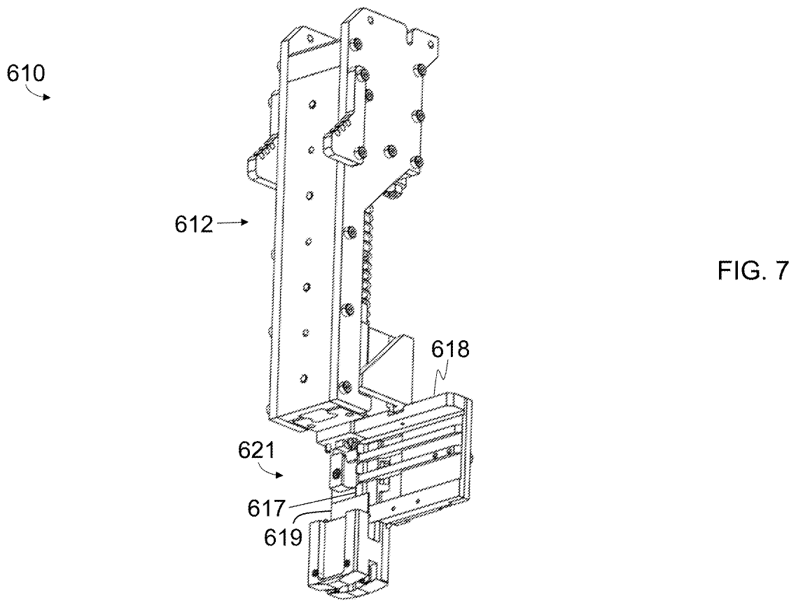

FIG. 7 is a lower front perspective view of the fastener tool 610 of FIG. 6A. The fastener tool 610 may include the driver 612, the plate 618, the feeder mechanism 617, the nose piece 619, and the fastener chamber 621.

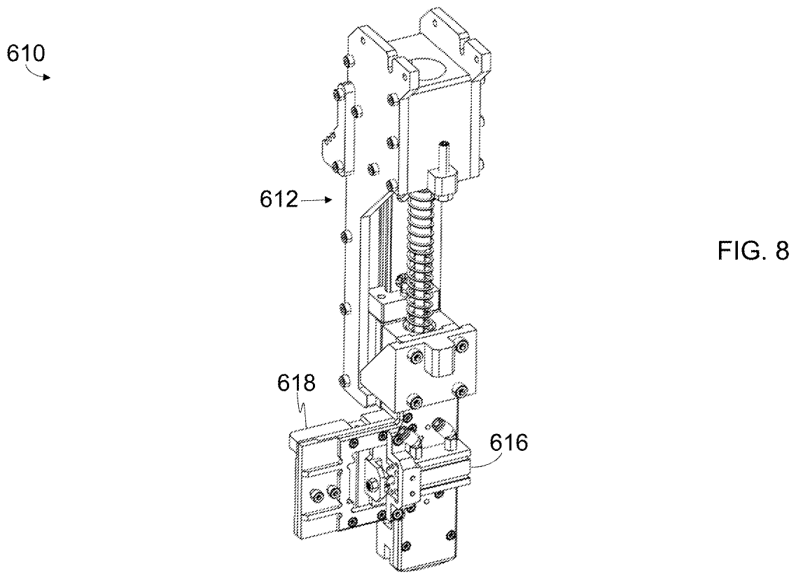

FIG. 8 is a back perspective view of the fastener tool 610 of FIG. 6A. The fastener tool 610 may include an actuator 616 configured to advance the fastener strip toward the driver 612. In some embodiments, the actuator 616 is a pneumatic actuator. In other embodiments, the actuator 616 is an electromagnetic actuator. The actuator 616 may be attached to the plate 618. In some embodiments, the actuator may extend through the plate 618.

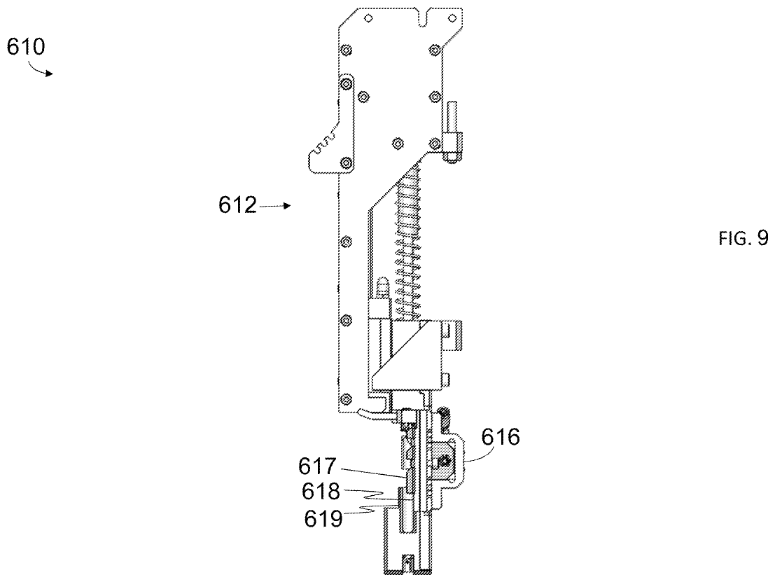

FIG. 9 is a right side view of the fastener tool 610 of FIG. 6A. The feeder mechanism 617 may be extend from the plate 618 to advance the fastener strip. The actuator may be coupled to the feeder mechanism to actuate the feeder mechanism 617. In some embodiments, the feeder mechanism 617 may include a wheel. The wheel may contact the fastener strip through the plate 618. The actuator 616 may spin the wheel, causing the fastener strip to advance toward the driver 612. In some embodiments, the feeder mechanism 617 may include a first wheel on a first side of the fastener strip and a second wheel on a second side of the fastener strip. The first wheel and the second wheel may contact the fastener strip. The actuator 616 may spin the first wheel and the second wheel, causing the fastener strip to advance toward the driver 612. In some embodiments, the feeder mechanism 617 may include a cog having teeth spaced at a distance equal to a distance between subsequent fasteners of the fastener strip. The actuator 616 may rotate the cog. The cog may hold a fastener of the fastener strip between its teeth and, as it rotates, advance the fastener strip such that the cog holds a subsequent fastener between its teeth.

In some embodiments, the feeder mechanism 617 may include a rigid member configured to push the fastener strip towards the driver. The rigid member may pass through the plate 618 from the second side to the first side to push the fastener strip toward the driver 612. In some embodiments, the rigid member may rotate to push the fastener strip toward the driver 612. The rigid member may be configured to push the fastener strip toward the driver 612 as the rigid member rotates in a first direction and not push the fastener strip away from the driver 612 as the rigid member rotates in a second direction opposite the first direction.

In some embodiments, the feeder mechanism 617 is driven by a movement of the driver 612 as it drives fasteners into the surface. In these embodiments, the feeder mechanism 617 may adjust the movement of the feeder strip.

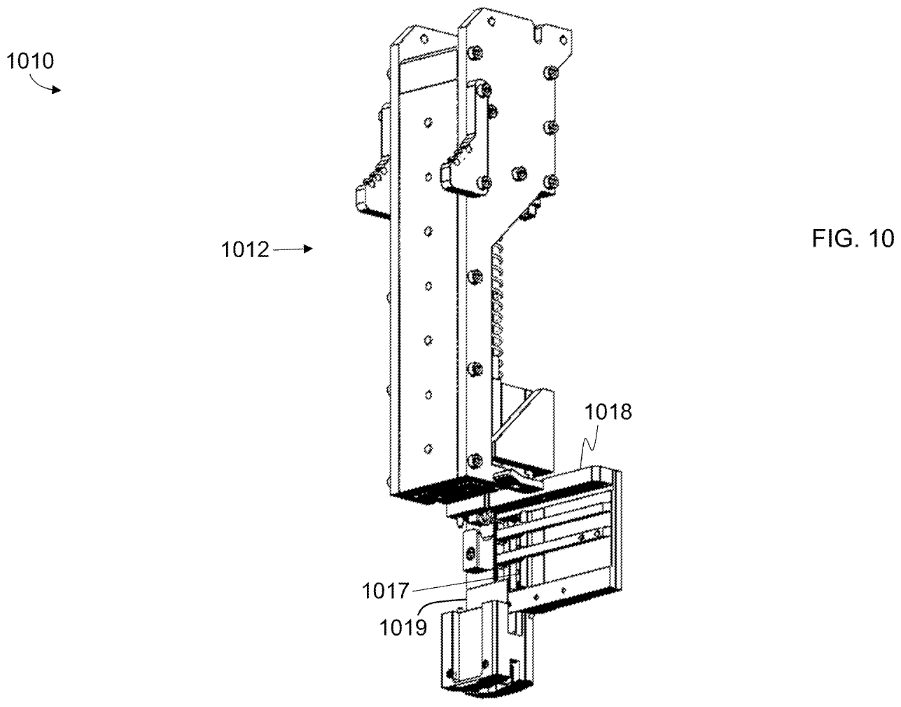

FIG. 10 is a lower perspective view of a fastener tool 1010 before a feeder mechanism 1017 is actuated, according to one embodiment of the present disclosure. The feeder mechanism 1017 may be actuated to advance a fastener strip toward a driver 1012 of the fastener tool 1010. The feeder mechanism 1017 may be actuated by an actuator (not shown) which causes the feeder mechanism 1017 to move and advance the fastener strip toward the driver 1012. The feeder mechanism 1017 may be part of or pass through a plate 1018 of the fastener tool 1010. The plate 1018 may be configured to receive the fastener strip. The fastener tool 1010 may include a nose piece 1019 configured to receive the fastener strip and keep the fastener strip from moving away from the plate 1018. The feeder mechanism 1017 may include one or more rigid members configured to engage the fastener strip and advance the fastener strip toward the driver 1012. The one or more rigid members may be similar to the one or more rigid members 624 of FIG. 6B. In some embodiments, the one or more rigid members may be flush with the plate 1018 before the feeder mechanism 1017 is actuated.

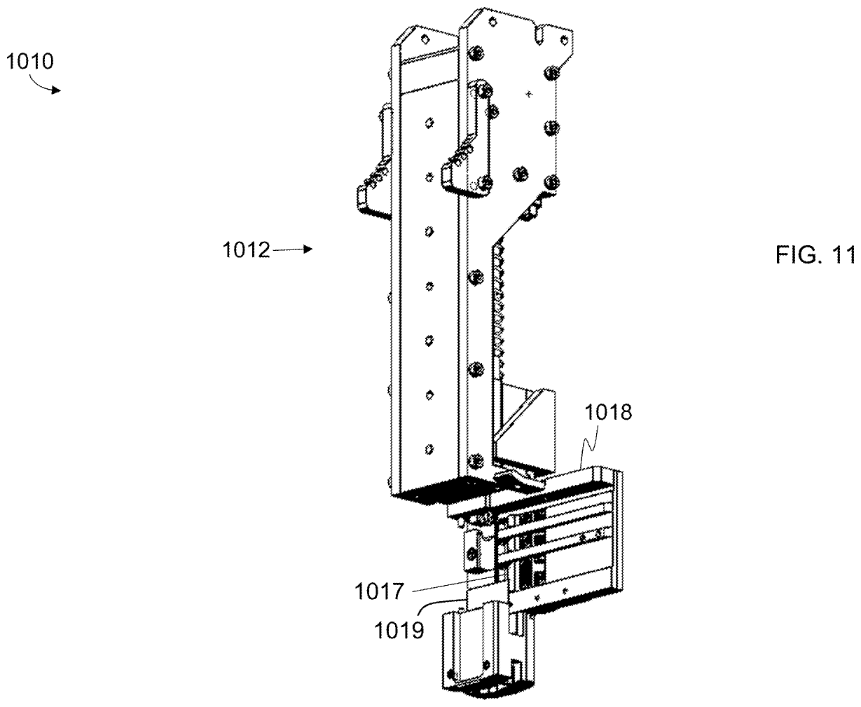

FIG. 11 is a lower perspective view of the fastener tool 1010 of FIG. 10 as the feeder mechanism 1017 is being actuated to engage a fastener strip. The feeder mechanism 1017 may rotate, causing the one or more rigid members to push against the fastener strip and advance the fastener strip along the plate 1018 toward the driver 1012 and the nose piece 1019.

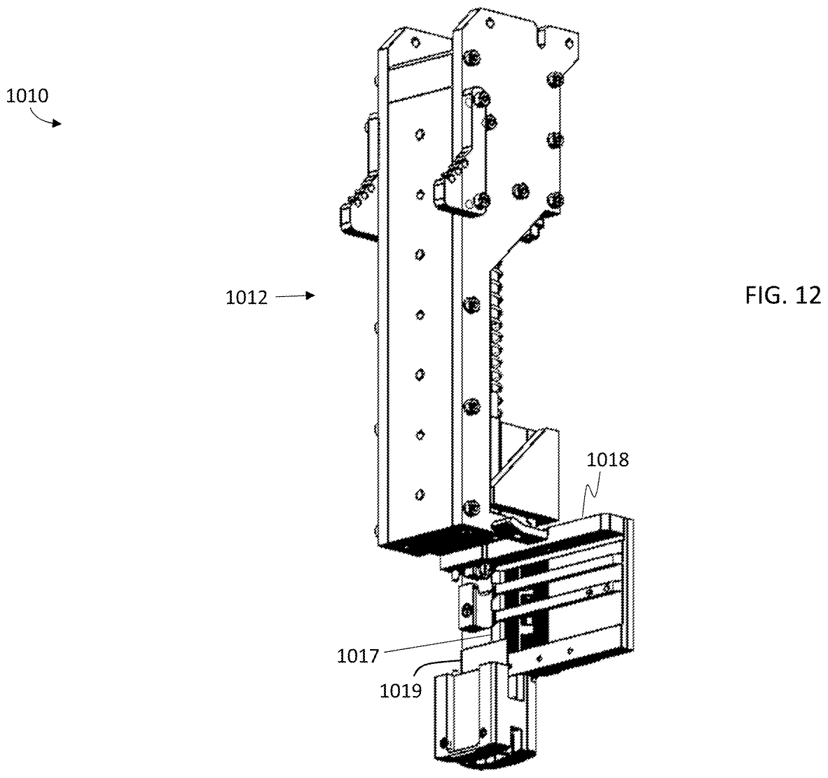

FIG. 12 is a lower perspective view of the fastener tool 1010 of FIG. 10 after the feeder mechanism 1017 is engaged. The feeder mechanism 1017, after being actuated and engaging the fastener strip to advance the fastener strip along the plate 1018 and move a fastener of the fastener strip below the driver 1012, may secure the fastener below the driver 1012, as discussed herein. The nose piece 1019 may be configured to secure the fastener below the driver 1012, as discussed herein.

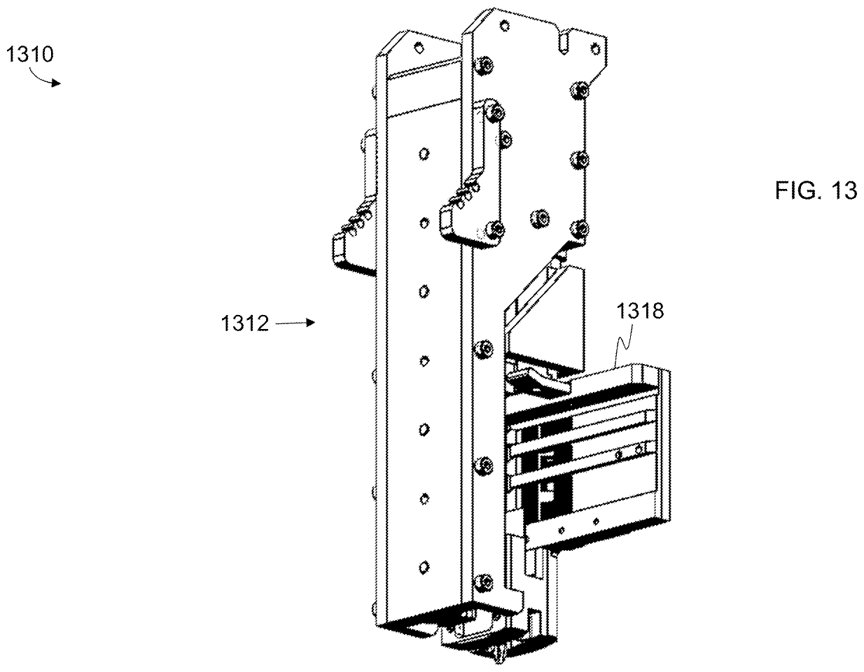

FIG. 13 is a lower perspective view of the fastener tool 1010 of FIG. 10 driving the fastener. The driver 1012 may move relative to the plate 1018 when driving the fastener. Relative to the driver 1012, the plate may move 1018. The driver 1012 may move relative to the plate when the fastener tool 1010 contacts the surface, such that the plate 1018 is static relative to the surface and the driver 1012 moves towards the surface, moving relative to the plate 1018 and the surface. The driver 1012 may drive the fastener out of the fastener strip when driving the fastener into the surface. The driver 1012 may move upwards relative to the plate 1318 to allow a subsequent fastener to be fed below the driver 1012 and then move downwards to drive the subsequent fastener into the surface.

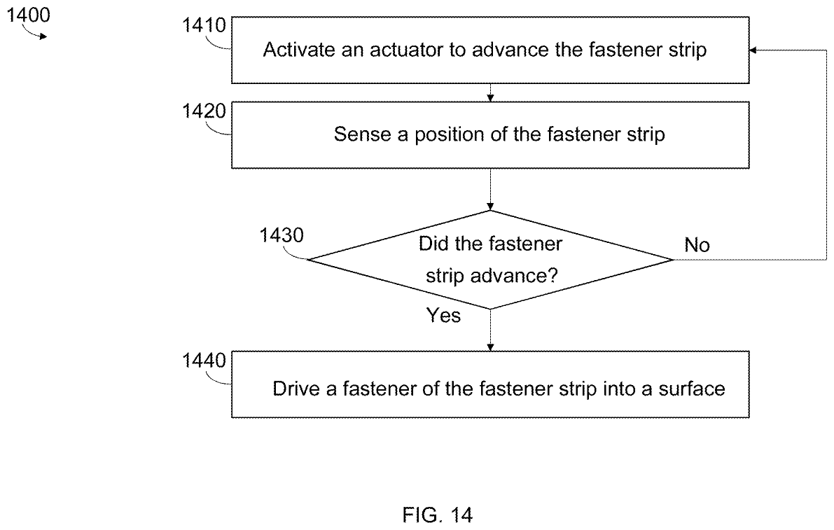

FIG. 14 is a flow chart illustrating a process 1400 for driving a fastener using a fastener tool, according to one embodiment of the present disclosure. The process 1400 may be performed by a fastener tool or a fastener system including the fastener tool (e.g., the fastener system 100 of FIG. 1A, the fastener tool 610 of FIG. 6, the fastener tool 1010 of FIG. 10). Additional, fewer, or alternate operations may be included in the process 1400. The operations shown may be performed in in different order than shown or concurrently.

At 1410, an actuator is activated or actuated to advance a fastener strip. The actuator may actuate a feeder mechanism which moves the fastener strip. The feeder mechanism may be moved by the actuator to advance the fastener strip toward a driver of the fastener tool, as discussed herein. At 1420, a position of the fastener strip is sensed. A sensor of the fastener tool senses the position of the fastener strip. The sensor may sense movement of the fastener strip. At 1430, the sensor determines whether the fastener strip advanced. In some embodiments, the sensor determines whether the fastener strip advanced a required distance. The required distance may be equal to a distance the fastener strip advances when one fastener is fed to the driver of the fastener tool. If the fastener strip advanced, at 1440, a fastener of the fastener strip is driven into a surface. The driver may drive the fastener of the fastener strip into the surface. In some embodiments, the driver only drives the fastener into the surface if the fastener strip advanced the required distance. If the fastener strip did not advance or did not advance the required distance, the actuator is again engaged at 1410 to advance the fastener strip. If the actuator is engaged a predetermined amount of times without advancing the fastener strip or without advancing the fastener strip the required distance, a signal is sent to an operator of the fastener tool.

### Examples

Some examples of embodiments of the present disclosure are as follows:

Example 1. A fastener gun including a driver configured to drive a fastener of a fastener strip, a plate coupled to the driver, wherein the plate is configured to receive the fastener strip, a nose piece coupled to the plate, wherein the nose piece is configured to hold the fastener strip adjacent the plate, and a feeder mechanism coupled to the plate and configured to advance the fastener strip towards the driver.

Example 2. The fastener gun of example 1, wherein the feeder mechanism comprises a pneumatic actuator.

Example 3. The fastener gun of example 1, wherein the feeder mechanism comprises an electromagnetic actuator.

Example 4. The fastener gun of example 1, wherein the feeder mechanism comprises a wheel.

Example 5. The fastener gun of example 1, wherein the feeder mechanism comprises a first wheel on a first side of the fastener strip and a second wheel on a second side of a fastener strip.

Example 6. The fastener gun of example 1, wherein the feeder mechanism comprises a cog.

Example 7. The fastener gun of example 1, wherein the cog includes teeth spaced at a distance equal to a distance between subsequent fasteners of the fastener strip.

Example 8. The fastener gun of example 1, wherein the feeder mechanism comprises a rigid member configured to push the fastener strip towards the driver.

Example 9. The fastener gun of example 8, wherein the feeder mechanism is located on a first side of the plate and the fastener strip is located on a second side of the plate.

Example 10. The fastener gun of example 9, wherein the rigid member passes through the plate to push the fastener strip towards the driver.

Example 11. The fastener gun of example 1, wherein the feeder mechanism is actuated by motion of the driver.

Example 12. A fastener gun comprising: a driver configured to drive a fastener of a fastener strip, a feeder mechanism configured to advance the fastener strip toward the driver, and a sensor configured to track movement of the fastener strip.

Example 13. The fastener gun of example 12, wherein the sensor comprises an optical sensor.

Example 14. The fastener gun of example 13, wherein the sensor comprises a laser sensor.

Example 15. The fastener gun of example 12, wherein the sensor comprises a magnetic sensor.

Example 16. The fastener gun of example 12, wherein the sensor comprises a proximity sensor.

Example 17. The fastener gun of example 12, wherein the sensor is further configured to determine whether the fastener strip advanced toward the driver such that one fastener entered the driver.

Example 18. The fastener gun of example 17, wherein the sensor is further configured to, in response to determining that the fastener strip advanced toward the driver such that one fastener entered the driver, send a signal to the driver to drive a fastener of the fastener strip.

Example 19. The fastener gun of example 17, wherein the sensor is further configured to, in response to determining that the fastener strip did not advance toward the driver such that one fastener entered the driver, send a signal to the feeder to advance the fastener strip toward the driver.

Example 20. The fastener gun of example 19, wherein the sensor is further configured to, in response to determining a predetermined number of times that the fastener strip did not advance toward the driver such that one fastener entered the driver, send an alert to an operator of the fastener gun.

Example 21. The fastener gun of example 12, further comprising a plate coupled to the driver, wherein the plate is configured to receive the fastener strip on a first side of the plate, and wherein the sensor is coupled to a second side of the plate.

Example 22. The fastener gun of example 21, wherein the plate includes an opening through which the sensor tracks the movement of the fastener strip.

Example 23. A fastener gun comprising: a driver configured to drive a fastener of a fastener strip, a plate removably attached to the driver, wherein the plate is configured to receive the fastener strip, a nose piece removably attached to the plate, wherein the nose piece is configured to hold the fastener strip adjacent the plate, and a feeder mechanism coupled to the plate and configured to advance the fastener strip towards the driver.

Example 24. The fastener gun of example 23, wherein the plate is configured to receive a second nose piece, wherein the second nose piece is removably attached to the plate in the place of the nose piece.

Example 25. The fastener gun of example 23, wherein the driver is configured to receive a second plate, wherein the second plate is removably attached to the driver in the place of the plate.

Example 26. The fastener gun of example 23, wherein the nose piece comprises a horizontal member and a vertical member, wherein the horizontal member extends orthogonal from the plate, wherein the vertical member extends upwards from the horizontal member, and wherein the vertical member is configured to hold the fastener strip adjacent the plate.

Any methods disclosed herein include one or more steps or actions for performing the described method. The method steps and/or actions may be interchanged with one another. In other words, unless a specific order of steps or actions is required for proper operation of the embodiment, the order and/or use of specific steps and/or actions may be modified. Moreover, sub-routines or only a portion of a method described herein may be a separate method within the scope of this disclosure. Stated otherwise, some methods may include only a portion of the steps described in a more detailed method.

Reference throughout this specification to “an embodiment” or “the embodiment” means that a particular feature, structure, or characteristic described in connection with that embodiment is included in at least one embodiment. Thus, these quoted phrases, or variations thereof, as recited throughout this specification are not necessarily all referring to the same embodiment.

Similarly, it should be appreciated by one of skill in the art with the benefit of this disclosure that in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element.

While the principles of this disclosure have been shown in various embodiments, many modifications of structure, arrangements, proportions, elements, materials, and components used in practice and that are particularly adapted for a specific environment and operating requirements may be used without departing from the principles and scope of this disclosure. These and other changes or modifications are intended to be included within the scope of the present disclosure.

The scope of the present invention should, therefore, be determined only by the following claims.

What is claimed is:

1. A fastener gun comprising:
a driver configured to drive a fastener of a fastener strip;
a plate coupled to the driver, wherein the plate is configured to receive the fastener strip;
a nose piece coupled to the plate, wherein the nose piece is configured to hold the fastener strip adjacent the plate; and
a feeder mechanism coupled to the plate and configured to advance the fastener strip towards the driver.

2. The fastener gun of claim 1, wherein the feeder mechanism comprises a pneumatic actuator.

3. The fastener gun of claim 1, wherein the feeder mechanism comprises an electromagnetic actuator.

4. The fastener gun of claim 1, wherein the feeder mechanism comprises a wheel.

5. The fastener gun of claim 1, wherein the feeder mechanism comprises a cog.

6. The fastener gun of claim 1, wherein the feeder mechanism comprises a rigid member configured to push the fastener strip towards the driver.

7. The fastener gun of claim 6, wherein the feeder mechanism is located on a first side of the plate and the fastener strip is located on a second side of the plate.

8. The fastener gun of claim 7, wherein the rigid member passes through the plate to push the fastener strip towards the driver.

9. The fastener gun of claim 1, wherein the feeder mechanism is actuated by motion of the driver.

10. A fastener gun comprising:
a driver configured to drive a fastener of a fastener strip;
a feeder mechanism configured to advance the fastener strip toward the driver; and
a sensor configured to track movement of the fastener strip.

11. The fastener gun of claim 10, wherein the sensor comprises at least one of an optical sensor, a laser sensor, a magnetic sensor, or a proximity sensor.

12. The fastener gun of claim 10, wherein the sensor is further configured to determine whether the fastener strip advanced toward the driver such that one fastener entered the driver.

13. The fastener gun of claim 12, wherein the sensor is further configured to, in response to determining that the fastener strip advanced toward the driver such that one fastener entered the driver, send a signal to the driver to drive a fastener of the fastener strip.

14. The fastener gun of claim 12, wherein the sensor is further configured to, in response to determining that the fastener strip did not advance toward the driver such that one fastener entered the driver, send a signal to the feeder to advance the fastener strip toward the driver.

15. The fastener gun of claim 14, wherein the sensor is further configured to, in response to determining a predetermined number of times that the fastener strip did not advance toward the driver such that one fastener entered the driver, send an alert to an operator of the fastener gun.

16. The fastener gun of claim 12, further comprising a plate coupled to the driver, wherein the plate is configured to receive the fastener strip on a first side of the plate, and wherein the sensor is coupled to a second side of the plate.

17. The fastener gun of claim 16, wherein the plate includes an opening through which the sensor tracks the movement of the fastener strip.

18. A fastener gun comprising:
a driver configured to drive a fastener of a fastener strip;
a plate removably attached to the driver, wherein the plate is configured to receive the fastener strip;
a nose piece removably attached to the plate, wherein the nose piece is configured to hold the fastener strip adjacent the plate; and
a feeder mechanism coupled to the plate and configured to advance the fastener strip towards the driver.

19. The fastener gun of claim 18, wherein the plate is configured to receive a second nose piece, wherein the second nose piece is removably attached to the plate in the place of the nose piece.

20. The fastener gun of claim 18, wherein the driver is configured to receive a second plate, wherein the second plate is removably attached to the driver in the place of the plate.
